(19) United States
(12) Patent Application Publication
(10) Pub. No.: US 2026/0252685 A1
(43) Pub. Date: Aug. 27, 2026

(54) Repeated Results Monitoring

(71) Applicant: Google LLC, Mountain View, CA (US)

(72) Inventors: Alexander Knop, Brooklyn, NY (US); Scott Schneider, Los Angeles, CA (US); Chienli Su, Anaheim, CA (US); Nicolas Gregory Ajalat, Culver City, CA (US); Dina Kurman, New York, NY (US)

(21) Appl. No.: 18/863,487

(22) PCT Filed: Mar. 6, 2024
(86) PCT No.: PCT/US2024/018659

§ 371 Date: Nov. 6, 2024

(51) Int. Cl. G06F 21/55; G06F 21/60; G06F 21/62; G06F 21/64

(52) U.S. Cl. CPC G06F 21/554; G06F 21/602; G06F 21/6227; G06F 21/64

(57) ABSTRACT

The technology is generally directed to protecting data privacy in query results. In response to a query, data responsive to the query results is identified. The responsive data can include rows of data. The rows of data are aggregated based on an aggregation function. A function or hash of the aggregated values may be used to generate a signature associated with the rows of data within the query results. The signatures of the current query may be compared to other signatures associated with the current query results and/or historical query result signatures, e.g., signatures associated with results of previously submitted queries. If the similarity of the signature associated with the current query result is above a threshold similarity to another signature, the query and its associated results are identified as a privacy attack. Preventative actions may be enabled in response to determining that the query is a privacy attack.

### BACKGROUND

Differential privacy is typically used to protect information and the anonymity of data when sharing information about a group. Differential privacy typically adds controlled randomness to released statistics, thereby making it substantially impossible for a bad actor to infer anything about a given individual within the group information. Typically, differential privacy will enact a limit on the number of queries executed by a user with respect to a given dataset. The controlled randomness is typically noise that is dependent upon the input data. However, as more and more queries associated with the data are submitted, the more likely there is to be a leak about individuals within the group data, thereby weakening the privacy of the individual.

### BRIEF SUMMARY

The technology is generally directed to protecting data privacy in query results. In response to a query, data responsive to the query results is identified. The responsive data can include rows of data. The rows of data are aggregated based on an aggregation function. A function or hash of the aggregated values may be used to generate a signature associated with the rows of data within the query results. The signatures of the current query may be compared to other signatures associated with the current query results and/or historical query result signatures, e.g., signatures associated with results of previously submitted queries. If the similarity of the signature associated with the current query result is above a threshold similarity to another signature, the query and its associated results are identified as a privacy attack. Preventative actions may be enabled in response to determining that the query is a privacy attack.

One aspect of the technology is directed to a method, comprising receiving, by one or more processors, a query, identifying, by the one or more processors, query results comprising data responsive to the query, generating, by the one or more processors, a signature associated with the responsive data, comparing, by the one or more processors, the signature to at least one of historical query signatures or another signature associated with the responsive data, and identifying, by the one or more processors, the query as an attack when the signature corresponds to at least one historical query signature or the other signature associated with the responsive data.

The responsive data includes a plurality of rows of data such that generating the signature associated with the responsive data further comprises aggregating, by the one or more processors, the responsive data per row to generate an aggregated value, and generating, by the one or more processors, the signature for each aggregated value. Aggregating the responsive data is further aggregated per entity. The method further comprises concatenating, by the one or more processors, the aggregated value with an identifier associated with the entity to generate a concatenated value, and hashing, by the one or more processors, the concatenated value to generate a per-entity hash value. Generating the signature associated with the responsive data further comprises identifying, by the one or more processors, one or more per-entity hash values for the aggregated values, and generating, by the one or more processors, the signature associated with the responsive data by hashing the one or more per-entity hash values.

Each row of data corresponds to an entity and includes statistical information associated with the entity. The statistical information comprises at least one of impressions or conversions. Generating the signature associated with the responsive data further comprises generating, by the one or more processors based on the entity and the statistical information associated with the entity, the signature for each row of data.

The method further comprises storing, in memory, the generated signature with the responsive data. The signature is generated as a function or a hash value of the responsive data. The signature is a representation of values of the responsive data. The representation is sets of pairs, and each pair of the sets of pairs maps a user to a corresponding value in the responsive data. When comparing the signature to the at least one historical query signature or the other signature, the method further comprises comparing, by the one or more processors executing an invertible bloom filter, the sets of pairs. When the query is identified as the attack, the method further comprises enabling, by the one or more processors, at least one preventative measure. The at least one preventative measure includes limiting query repetitions, limiting access to a dataset comprising the responsive data, inserting additional noise to the responsive data, or inserting a delay before providing the query results. The at least one historical query signature corresponds to a previously generated signature for data responsive to a previously received query. The attack is an averaging attack.

Another aspect of the technology is directed to a system comprising one or more processors. The one or more processors are configured to receive a query, identify query results comprising data responsive to the query, generate a signature associated with the responsive data, compare the signature to at least one of historical query signatures or another signature associated with the responsive data, and identify the query as an attack when the signature corresponds to at least one historical query signature or the other signature associated with the responsive data.

Yet another aspect of the technology is directed to one or more non-transitory computer-readable storage media encoding instructions that, when executed by one or more processors, cause the one or more processors to perform operations comprising receiving a query, identifying query results comprising data responsive to the query, generating a signature associated with the responsive data, comparing the signature to at least one of historical query signatures or another signature associated with the responsive data and identifying the query as an attack when the signature corresponds to at least one historical query signature or the other signature associated with the responsive data.

### BRIEF DESCRIPTION OF THE DRAWINGS

FIG. 1 is an example sequence diagram that illustrates steps for identifying repeated query results according to aspects of the disclosure.

FIG. 2 is example responsive content according to aspects of the disclosure.

FIG. 3 is example responsive content with a baseline amount of noise according to aspects of the disclosure.

FIG. 4 is example data used to generate a signature for responsive content according to aspects of the disclosure.

FIG. 5 illustrates an example comparison of signatures according to aspects of the disclosure.

FIG. 6 is a block diagram of an example system according to aspects of the disclosure.

FIG. 7 is a flow diagram of an example method for identifying repeated query results according to aspects of the disclosure.

### DETAILED DESCRIPTION

The technology is generally directed to protecting the privacy of data in results of an initial query by detecting and preventing repeated queries seeking substantially similar results. For each query of a database, a signature associated with the query results is created. The signature is a function or hash of the aggregated values associated with the query results. There may be one signature per aggregated result, such that a signature is generated per aggregation function time the number of output rows. For example, the query results may include rows of data, with each pre-aggregated row associated with a user. The rows of data may be aggregated based on the aggregation function. Each aggregated row may be associated with one or more users. A signature may be generated for each aggregated row of data. The signatures associated with the query results are compared to historical query result signatures and/or another signature associated with the query results to determine whether the query results are substantially similar to at least one historical query result or another query result. In cases where the similarity between the query result and the historical query result is above a threshold, the query may be identified as a privacy attack. In response to determining that the query is a privacy attack, one or more preventative actions may be taken to prevent the user submitting the query from continuing the attack.

The privacy attack may be, in some examples, an averaging attack. According to some examples, the query results may include a baseline level of noise. For example, when identifying the responsive data and generating the query results in response to receiving the query, the system may insert a baseline level of noise in the query results. The baseline level of noise can prevent a user receiving the query results from readily being able to identify personal and/or private information within the query results. However, in cases where queries intended to receive substantially similar responsive data are submitted continuously, e.g., as an averaging attack, the baseline level of noise is no longer sufficient to protect the privacy of the information within the query results. In particular, the baseline level of noise prevents a user from being able to identify much, if anything, about a single entity's value from a single aggregated result, e.g., the query results provided as a response to the query. However, after receiving multiple aggregated results, with the same baseline level of noise, the user can average the results together. The baseline level of noise for each aggregated result is independently determined and will average to a small value, which will allow the user, e. g, an attacker or bad actor, to get very close to the pre-noised responsive data. The attacker may then be able to identify information about the entity that was intended to be kept private.

As an example, if a user computes, or queries, “SELECT SUM(x), SUM(2*x), SUM(3*x), . . . ” the user would be able to divide results by 1, 2, 3, etc. and then average those results to identify the private information. In some examples, the user may construct a query that computes results that are identical, except each has a few additional entities included in the results. This attack can work in two ways. First, it can be part of a regular averaging attack. If the user knows values for the added entities, the user can subtract these values from the aggregated results and then average values to identify the private information. Second, the user might get many pairs of values, where in each pair, the different entity is a particular entity the user wants to attack. The difference between these two results with noise is the targeted entity's value plus the two results' noise. The user can do this with many pairs, where the two signatures for a pair may be very different from signatures for other pairs. The user can compute a difference for each pair, average all these differences together, and get data on the targeted user with lower noise.

By generating signatures associated with the query results and comparing the generated signatures to historical query result signatures and/or other signatures associated with the query results, privacy attacks, such as an averaging attack, may be disrupted and/or prevented. This can prevent bad actors from identifying information intended to be kept private and/or anonymous. In particular, the generation and use of signatures associated with the query results allows for the system to detect whether the same, or substantially similar, responsive data has been generated more than once. For example, a signature for a current query result is generated and compared to another signature associated with the query result and/or historical query result signatures, e.g., signatures generated for previous query results. When the signature for the current query result is substantially similar to another signature and/or a historical query result signature, the system can determine that the query results, e.g., responsive data, has been previously generated and/or provided. Upon detection that the query results have already been generated and/or provided, the system can implement one or more preventative actions to prevent a bad actor from being able to identify private information from the query results, thereby inhibiting a privacy attack.

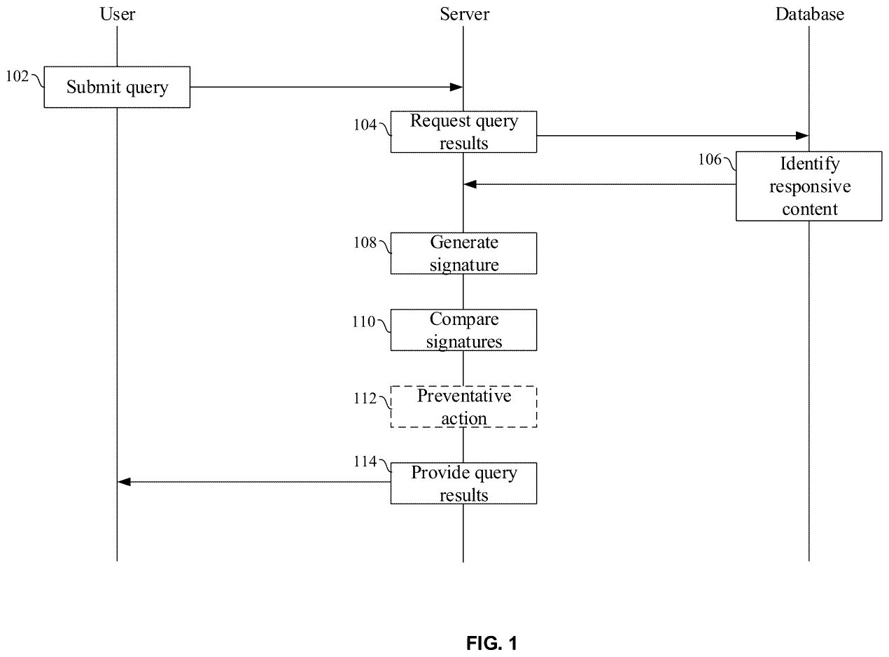

FIG. 1 is an example sequence diagram of steps that may occur among a user, a server, and a database. The following operations do not have to be performed in the same order described below. Rather, various operations can be handled in a different order or simultaneously, and operations may be added or omitted. For example, operations shown with dashed lines may be optional and, therefore, may be performed in some examples but not others.

In block 102, a system, including the server, may receive a query from a user. For example, the user may submit a query and the query may be received by the server. The query may be to query data within the database. The database may be a relational database in which statistical information associated with an entity is stored. The query may be a search query. In some examples, the query may be a question, inquiry, or statistical query associated with the data stored in the database.

In block 104, the server may request query results from a database.

In block 106, the database, in response to the request, may identify responsive content. The responsive content may be content, such as data, that answers the user's query. In some examples, the responsive content numerical values are responsive to the query.

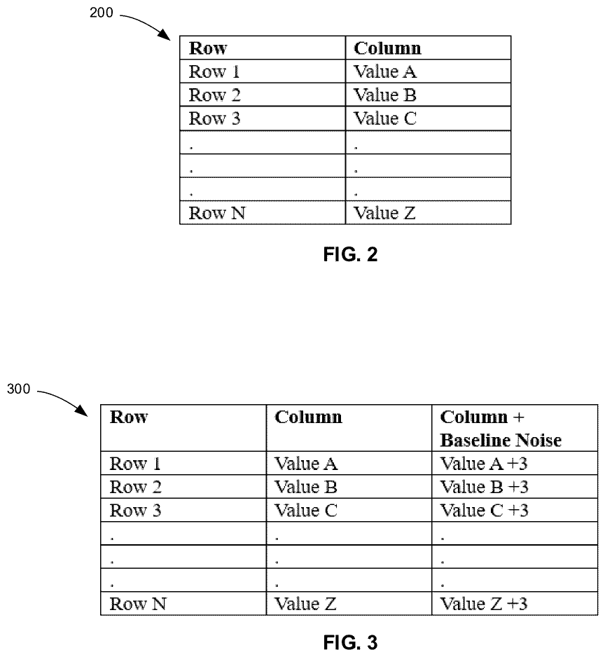

FIG. 2 illustrates example responsive content. As shown, the responsive content 200 may be a table comprising rows of data, e. g, Rows 1-N. The rows of data may include, for example, numerical values. Each row of data (Rows 1-N) may correspond to an entity and include statistical information, e.g., numerical values, associated with the entity. For example, Row 1 may correspond to “Entity 1”, Row 2 may correspond to “Entity 2”, and the like. The statistical information may be provided in one or more columns. While only a single column is shown in the responsive content 200, the responsive content may have a plurality of columns, e.g., Columns 1-M. Accordingly, the responsive content 200 shown in FIG. 2 is just one example and is not intended to be limiting.

As an example, the query may be to identify a number of users who have viewed an advertisement for a given merchant. The responsive data may be a table identifying the number of users who have viewed the advertisement for the merchant. In some examples, the table may include rows. The rows may separate the data based on features associated with the users. For example, the rows may be based on locations, age ranges, or the like. The statistical information for each row may be the number of users in a given location, age range, or the like viewed the advertisement for the merchant. In such an example, the responsive content 200 illustrated in FIG. 2 may be for a single merchant, the rows being associated with a feature of the users viewing the advertisement for the merchant, and the column providing statistical information associated with the feature and the merchant.

FIG. 3 illustrates example responsive content 300 with a baseline level of noise added. For example, when identifying the responsive content and generating the query results, a baseline level of noise may be added to the responsive content to prevent the user receiving the query results from readily being able to identify personal and/or private information within the query results. As shown in FIG. 3, the baseline level of noise added to the query results may be the same value and/or amount for each row of data. In some examples, the baseline level of noise added to each row in the responsive content may be different. Accordingly, the example of adding the same amount of noise to each row is just one example and is not intended to be limiting.

Referring back to FIG. 1, in block 108, the server may generate a signature for an aggregated result of the responsive data. According to some examples, the responsive data may include a table having a plurality of rows. The values within the row may be numerical values, such as statistical information associated with an entity. Each pre-aggregated row is associated with one entity, or user. Each aggregated row may be associated with multiple entities, or users. The aggregated rows associated may be generated based on each aggregation function. The aggregation function may include “COUNT( )” or “SUM( )”. According to some examples, an entity may have several unaggregated rows contributed to each aggregated result. Continuing with the example, about, regarding advertisements, if the responsive data includes one row for each advertisement impression, e.g., each instance of a user being shown a given advertisement, and the query includes “COUNT(*)”, an entity's contribution to a result is equal to the entity's number of unaggregated rows in that result.

One or more signatures may be generated using a function or hash of the values within the aggregated row. According to some examples, the data within a given aggregated row may be concatenated as a string and used to generate the signature using a function or as a hash.

In some examples, when processing each query, the server may create a plurality of signatures. For example, one signature may be generated per aggregated value, e.g., one signature may be generated per aggregation function multiplied by the number of output rows. The aggregation function may be, for example, “COUNT( )” or “SUM( )”. In some examples, signatures may be generated for rows that are not provided as part of the query results. In another example, multiple signatures may be generated per aggregated value.

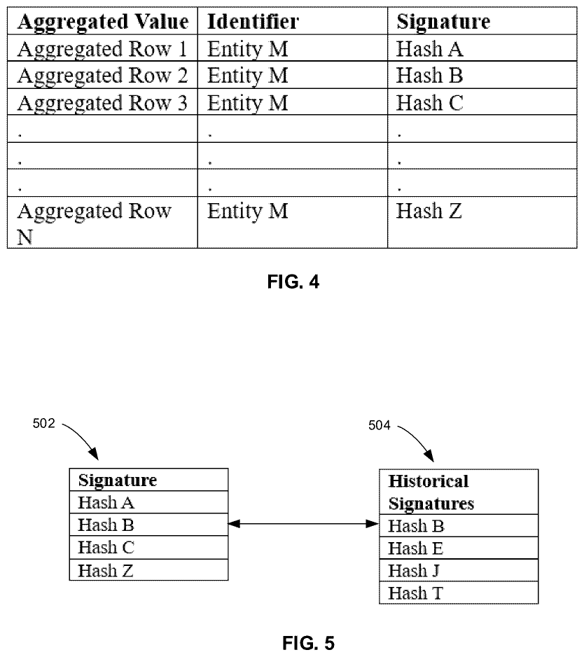

FIG. 4 illustrates an example of data used to generate the signatures. As shown, to generate the signatures, the values that are per output row in the responsive data and per entity are aggregated. An identifier associated with the entity is concatenated with the aggregated value. The concatenated value is then hashed using a hash function. The hash function may be, for example, MD5, SHA2/3, or the like. The per-entity hashed concatenated values are then identified such that the per-entity hashed concatenate values are hashed together into a single value, e.g., the signature, associated with the query results. The hash function to aggregate the per-entity hashed concatenated values can be an order-independent one, such as BIT_XOR( ), or it could be an ordered concatenation, such as STRING_AGG(per_user_hash ORDERED BY per_user_hash)) followed by any hash function, e.g. MD5, SHA2/3, or the like.

Continuing with the example, above, regarding advertisements, a signature may be generated for each aggregated row of data for the table indicating the number of users that viewed the advertisement of the merchant. In examples where the table includes a plurality of rows, each row corresponding to a different location, a signature for each row may be generated.

According to some examples, the signature may be generated as a representation of the responsive data. For example, the representation may be a pair of values, such as X and Y values. One value of the pair of values may correspond to the user and the other value of the pair of values may correspond to the value associated with the user. For example, the value associated with the user may be the age or the location of the user. In the example where the database is for information about advertisements, the value may be a conversion value for a given advertisement, an impression value for a given advertisement, or the like.

Referring back to FIG. 1, in block 110, the signature associated with the query results may be compared to signatures of historical query results and/or other signatures associated with the same query. Historical queries results may be, for example, queries results associated with queries previously submitted by the user. In some examples, the historical query results may be query results associated with queries previously submitted by another user, e.g., a user different from the user submitting the current query.

In examples where the signature is a set of values, the sets of values may be compared using data structures that support locality sensitive hashing (“LSH”), such as an Invertible Bloom Filter (“IBF”). The comparison of the sets of values may provide an indication as to whether the current query is a repeated query and, therefore, part of an attack.

FIG. 5 illustrates a comparison of current query result signatures to historical query results signatures and/or other signatures. The other signatures may be, for example, signatures within the current query results signatures. As shown in FIG. 5, the current query result signatures 502 include Hash A, B, C, and Z. The historical query results signatures 504 include Hah B, E, J, and T. The signatures within the current query result signatures 502 may be compared to one another. Such a comparison would, in this example, indicate that there are no two signatures in the current query result signatures 502 that are substantially the same. The signatures within the current query result signatures 502 may be compared to the historical query results signatures 504. Such a comparison would, in this example, indicate that Hash B from the current query result signatures 502 is substantially similar to Hash B from the historical query result signatures 504. When the comparison results in a detection of substantially similar signatures, the query results may be identified as repeated query results.

By comparing the signature of the query results to historical query result signatures, repeated query results may be detected. Repeated queries results may be query results that are the same or substantially similar to query results of a previous query. In some examples, repeated query results may include slight differences based on changes to the query, whether the query joins with external data, or if the data within the database changes. In another example, a repeated query result may be a query result in which the signature of the query result substantially corresponds to at least one historical query result signature and/or the other signature from the current query. A query result may be a repeated query result regardless as to whether the text of the query is identical, slightly different, or completely different from the text of a historical query.

The signature of the current query result may be identical to the historical query result signature to be identified as a repeated query result. In some examples, a repeated query result may be a query in which the similarity between the signature of the query result and the historical query result signature is above a threshold. The similarity may be detected using an IBF. In one example, the IBF may detect that the aggregated results, and the associated signatures, are a multiple of another aggregated result, and its associated signature. For example, a first aggregated result may be for the function “SUM(x)” and the second aggregated result may be for the function “SUM(x*10)”, such that the second aggregated result is a multiple of 10 of the first aggregated result. In another example, the IBF may detect that the current query results are slightly different from the historical query results. For example, a small number of entities may have different contributions in two signatures. The IBF detection techniques may, in some examples, work in combination. For example, for most entities, the ratio of their contributions to two signatures may be “R”, but a few entities may have different contribution ratios, such as “S” or “T”.

The use of signatures allows for repeated queries to be readily detected. Repeated queries are typically part of attacks seeking to identify information from within a database that is intended to remain anonymous and/or private.

One type of attack is an averaging attack in which the attacker has submitted multiple queries seeking the same or substantially similar query results. Without the use of signatures, attackers are able to bypass the initial noise that was added to the query results thereby allowing the attacker to identify the personal and/or private information within the query results. In contrast, the use of signatures to identify repeated queries allows for preventative actions to be taken before an attack can be used to identify the personal and/or private information within the query results.

According to some examples, comparing the signatures associated with the query results allows for more effective and efficient identification of repeated query results. For example, two queries seeking similar results may be submitted. A first query may be for “4 or more bedroom houses in New Jersey” and a second query may be for “houses with more than 3 bedrooms and a pool.” The query results for the first and second query may be substantially similar, as both queries will identify houses with at least 4 bedrooms. However, comparing the terms of the queries themselves may determine that the queries are different, e.g., “4 or more bedroom houses” is different from “more than 3 bedrooms”, and, therefore, does not detect repeated results. In contrast, the hash, or signature, associated with the results for the first and second query may be substantially similar as both queries are seeking houses in New Jersey with 4 or more bedrooms. Based on the comparison of the signatures associated with the query results for the first and second queries, the system can determine whether the query results are repeated query results.

Referring back to FIG. 1, in block 114, in examples where the query is not identified as an attack, the query results may be provided to the user. In examples where the query is identified as an attack, the query results may be provided to the user after the preventative action is enacted. In such an example, the query results may be provided after inserting additional noise, after a delay, or the like. In some examples, where the query is identified as an attack, the user may be prevented from submitting additional queries for a threshold period of time. In yet another example, when the query is identified as an attack, the user may be prevented from submitting queries for data from the particular database.

However, in examples where the query is identified as an attack, in block 112, such as when Hash B in the current query result signatures 502 is substantially the same to Hash B of the historical query result signatures 504, the system may enable one or more preventative actions or measures before providing the query results to the user. The preventative actions may include, for example, limiting query repetitions, limiting access to a dataset comprising the responsive data, inserting additional noise to the responsive data, inserting a delay before providing the query results, or the like. According to some examples, the preventative action may be enabled at the first sign of a repeated query. For example, it may take a single match between the signature of the current query and a historical query signature for the preventative action to be enabled. In some examples, the preventative action may be enabled after a threshold number of matches between the current query signature and another signature.

Limiting query repetitions may include, for example, limiting the number of times the same query and/or similar queries can be submitted within a certain period of time. For example, after a query is identified as an attack, e.g., the signature of the query corresponds to a signature of a historical query and/or another signature of the current query, the attacker may be prevented from submitting the same query again. In some examples, the attacker may be prevented from submitting a query seeking the same and/or substantially similar query results.

As an example, after the query is identified as an attack, the attacker may be prevented from submitting another query for a threshold period of time. The other query may, in some examples, be the same query or a different query. The threshold period of time may be determined based on how many times the attacker has submitted the same query. For example, if the attacker has submitted the same query five times the threshold period of time may be 10 seconds, if the attacker has submitted the same query ten times the threshold period of time may be 20 seconds, and the like. Accordingly, the threshold period of time may dynamically change based on the number of times the attacker attempts to submit the same query, e.g., a query having a signature corresponding to the signature of a historical query.

In some examples, when an attack is identified based on the current query having the same signature as the signature of a historical query, access to the database may be limited. For example, the system may prevent an attacker from being able to access the data within the database. In some examples, the system may identify the information the attacker is trying to access. For example, if the queries are directed to certain information within the database, the system may prevent the attacker from being able to access the identified information.

According to some examples, when a query is identified as an attack, additional noise may be inserted into the query results. In some examples, each time a duplicative query is submitted, a greater magnitude of additional noise may be inserted. The larger the magnitude of inserted noise corresponds to the number of repetitions of the query an attacker needs to submit to identify the private information. Therefore, even if the attacker continues to submit the duplicative query, the system will continue to inject noise of greater and greater magnitude, thereby preventing the attack.

In some examples, in response to identifying the query as an attack based on the comparison of the signatures, a delay may be inserted before providing the query results. The duration of the delay may be determined based on the similarity between queries, how many times the same query has been submitted, or the like. For example, the first time a repeated query is identified the delay may be one second, the second time the repeated query is identified the delay may be ten seconds, and the like. Including and/or increasing the delay before returning the query results can make it more difficult for an attacker to launch a successful averaging attack. By including and/or increasing the delay before returning the query results, the number of queries the attacker can submit may be limited. Limiting the number of queries the attacker can submit limits the number of leaks, or attacks, the attacker can create.

### Example Systems

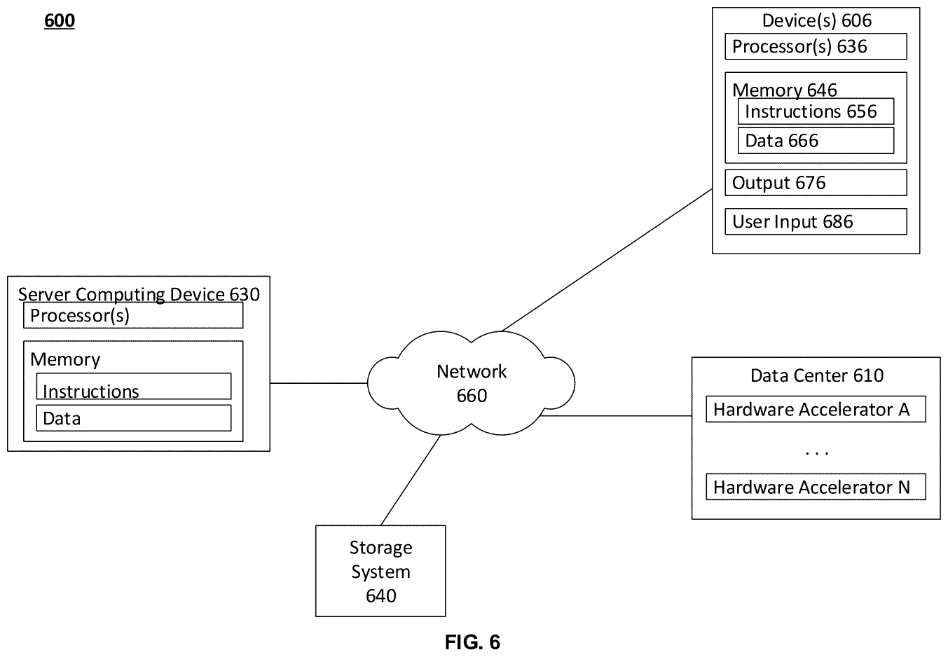

FIG. 6 illustrates an example system 600 in which the features described above may be implemented. It should not be considered limiting the scope of the disclosure or usefulness of the features described herein. In this example, system 600 may include device(s) 606, server computing device 630, storage system 640, and network 660.

Each device 606 may be a personal computing device intended for use by a respective user. The device 606 may include one or more processors 636, memory 646, data 666 and instructions 656. Each device 606 may also include an output 676, user input 686, and location sensor 696696. By way of example only, devices 606 may be mobile phones or devices such as a wireless-enabled PDA, smartphones, a tablet PC, a wearable computing device (e.g., a smartwatch, AR/VR headset, smart helmet, etc.), a netbook that is capable of obtaining information via the Internet or other networks, or a smart home device, such as a home assistant, smart thermostat, smart doorbell, smart light, etc.

Memory 646 of device 606 may store information that is accessible by processor 636. Memory 646 may also include data that can be retrieved, manipulated or stored by the processor 636. The memory 646 may be of any non-transitory type capable of storing information accessible by the processor 636, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 646 may store information that is accessible by the processors 636, including instructions 656 that may be executed by processors 636, and data 666.

Data 666 may be retrieved, stored or modified by processors 636 in accordance with instructions 656. For instance, although the present disclosure is not limited by a particular data structure, the data 666 may be stored in computer registers, in a relational database as a table having a plurality of different fields and records, XML documents, or flat files. The data 666 may also be formatted in a computer-readable format such as, but not limited to, binary values, ASCII or Unicode. By further way of example only, the data 666 may comprise information sufficient to identify the relevant information, such as numbers, descriptive text, proprietary codes, pointers, references to data stored in other memories (including other network locations) or information that is used by a function to calculate the relevant data.

The instructions 656 can be any set of instructions to be executed directly, such as machine code, or indirectly, such as scripts, by the processor 636. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 636 may include any conventional processors, such as a commercially available CPU or microprocessor. Alternatively, the processor can be a dedicated component such as an ASIC or other hardware-based processor. Although not necessary, computing devices 606 may include specialized hardware components to perform specific computing functions faster or more efficiently.

Although FIG. 6 functionally illustrates the processor, memory, and other elements of devices 606 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 606. Accordingly, references to a processor or device will be understood to include references to a collection of processors or devices or memories that may or may not operate in parallel.

Output 676 may be a display, such as a monitor having a screen, a touch-screen, a projector, or a television. The display 676 of the one or more computing devices 606 may electronically display information to a user via a graphical user interface (“GUI”) or other types of user interfaces. For example, as will be discussed below, display 676 may electronically display query results.

The user input 686 may be a mouse, keyboard, touch-screen, microphone, or any other type of input.

The devices 606 can be at various nodes of a network 660 and capable of directly and indirectly communicating with other nodes of network 660. Although one device is depicted in FIG. 6, it should be appreciated that a typical system can include one or more devices, with each device being at a different node of network 660. The network 660 and intervening nodes described herein can be interconnected using various protocols and systems, such that the network can be part of the Internet, World Wide Web, specific intranets, wide area networks, or local networks. The network 660 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 600 may include one or more server computing devices 630 having a plurality of computing devices, e.g., a load balanced server farm, that exchange information with different nodes of a network for the purpose of receiving, processing and transmitting the data to and from other computing devices. For instance, one or more server computing devices 630 may be a web server that is capable of communicating with the one or more client computing devices 606 via the network 660. In addition, server computing device 630 may use network 660 to transmit and present information to a user of one of the other computing devices 606.

Server computing device 630 may include one or more processors, memory, instructions, data, etc. These components operate in the same or similar fashion as those described above with respect to computing device 606.

According to some examples, the server computing device 630 may be connected over the network to a data center 610 housing any number of hardware accelerators. The data center 610 can be one of multiple data centers or other facilities in which various types of computing devices, such as hardware accelerators, are located. Computing resources housed in the data center can be specified for repeated results monitoring, including identifying repeated query results, or the like.

The server computing device 630 can be configured to receive queries from the client computing device 606 on computing resources in the data center 610. For example, the environment can be part of a computing platform configured to provide a variety of services to users, through various user interfaces and/or application programming interfaces (APIs) exposing the platform services. The variety of services can include identifying content responsive to the query, determining whether query results are repeated query results, or the like. The client computing device 606 can transmit input data associated with a query. The server computing device 630 can receive the input data and, in response, identify and provide for output query results. When identifying the query results, the server computing device 630 can generate a signature for the query results. The generated signature may be compared to other signatures associated with the query results and/or historical query signatures. Based on the comparison, the server computing device 630 can determine whether the query results are repeated query results. In examples where the query results are repeated query results, the server computing device 630 can enable one or more preventative measures.

As other examples of potential services provided by a platform implementing the environment, the server computing device can maintain a variety of models in accordance with different constraints available at the data center. For example, the server computing device can maintain different families for deploying models on various types of TPUs and/or GPUs housed in the data center or otherwise available for processing.

### Example Methods

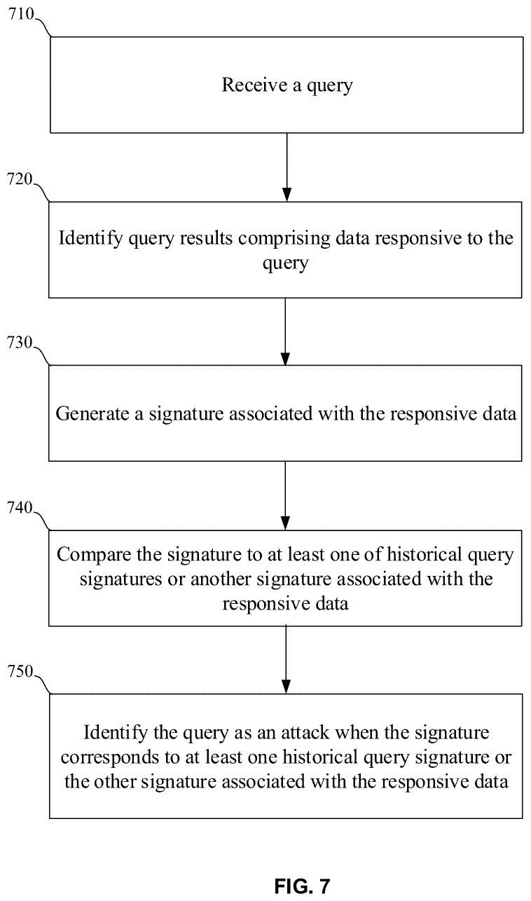

FIG. 7 is a flow diagram for an example method of identifying repeated results. The following operations do not have to be performed in the precise order described below. Rather, various operations can be handled in a different order or simultaneously, and operations may be added or omitted.

In block 710, a query may be received. The query may be received by one or more processors, such as server computing device 630.

In block 720, query results comprising data responsive to the query may be identified. The responsive data may be, for example, a table of data. In such an example, the responsive data includes a plurality of rows of data. Each row may correspond to an entity and include statistical information associated with the entity. The entity may be, in some examples, a merchant, a user, an advertiser, or the like. According to some examples, the row(s) must be associated with either the same set of entities/users or a mostly similar set. The statistical information may include at least one of impressions or conversions. For example, if the responsive data is associated with an advertisement for a given entity, the responsive data may include an indication of how many impressions, or views, are associated with the advertisement, how many clicks were received, how many conversions are associated with the advertisement, or the like.

In block 730, a signature associated with the responsive data may be generated. The signature may be a representation of values of the responsive data. The signature may be generated as a function or a hash value of the responsive data.

In some examples, the signature may be generated based on the entity and the statistical information associated with the entity. To generate the signature, the rows of data in the responsive data may be aggregated on a per row basis. Aggregating the responsive data on a per row basis generates an aggregated value. The aggregated value may be on a per row basis. The signature associated with the responsive data may be generated for each aggregated value.

According to some examples, the responsive data may further be aggregated per entity, in addition to per row. In such an example, the aggregated value for a given row may be concatenated with an identifier associated with the entity to generate a concatenated value. The concatenated value may be hashed to generate a per-entity hash value. In such an example, when generating the signature for the responsive data, one or more per-entity hash values for the aggregated values may be identified. The signature associated with the responsive data is generated by hashing the one or more per-entity hash values.

The generated signature may be stored in memory. In some examples, the generated signature may be stored in memory with the query results. The generated signature may be stored in memory on the server computing device, storage system 640, user computing device 606, or the like.

In block 740, the generated signature may be compared to at least one of historical query signatures or another signature associated with the responsive data. The at least one historical query signature corresponds to a previously generated signature for data responsive to a previously received query.

According to some examples, the representation of values of the responsive data may be sets of pairs. Each pair of the sets of pairs may map a user to a corresponding value in the responsive data. When comparing the signature to at least one historical signature or the other signature associated with the responsive data, the sets of pairs may be compared. In some examples, the sets of pairs may be compared by executing an invertible bloom filter.

In block 750, the query may be identified as an attack when the signature corresponds to at least one historical signature or the other signature associated with the responsive data. The attack may be, for example, an averaging attack. In examples when the query is identified as an attack, at least one preventative measure may be enabled. The preventative measure may include, for example, limiting query repetitions, limiting access to a dataset comprising the responsive data, inserting additional noise to the responsive data, or inserting a delay before providing the query results.

With just the addition of baseline noise, an attacker can circumvent the privacy of an individual's information without a group of information if enough queries seeking the same and/or substantially similar results are submitted. To mitigate this risk, and allow for additional preventative actions to be taken, signatures associated with the responsive data are generated. The use of signatures, which are a representation of the responsive data, allows an efficient comparison of current query results to other query results, including historical query results. When the signature associated with the responsive data of the current query is the same and/or above a threshold similarity of another signature, e.g. a historical query signature or another signature associated with the current query results, the query may be identified as an attack. The generation and comparison of signatures is less computationally intensive as compared to comparing rows and rows of responsive data, as the responsive data can be vast in size. Moreover, the comparison of signatures can quickly identify an attack and enable preventative measures to prevent private information from being detected by an attacker.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on its software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand-alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, by one or more processors, a query;
identifying, by the one or more processors, query results comprising data responsive to the query;
generating, by the one or more processors, a signature associated with the responsive data;
comparing, by the one or more processors, the signature to at least one of historical query signatures or another signature associated with the responsive data; and
identifying, by the one or more processors, the query as an attack when the signature corresponds to at least one historical query signature or the other signature associated with the responsive data.

2. The method of claim 1, wherein the responsive data includes a plurality of rows of data such that generating the signature associated with the responsive data further comprises:
aggregating, by the one or more processors, the responsive data per row to generate an aggregated value; and
generating, by the one or more processors, the signature for each aggregated value.

3. The method of claim 2, wherein aggregating the responsive data is further aggregated per entity, and the method further comprises:
concatenating, by the one or more processors, the aggregated value with an identifier associated with the entity to generate a concatenated value; and
hashing, by the one or more processors, the concatenated value to generate a per-entity hash value.

4. The method of claim 3, wherein generating the signature associated with the responsive data further comprises:
identifying, by the one or more processors, one or more per-entity hash values for the aggregated values; and
generating, by the one or more processors, the signature associated with the responsive data by hashing the one or more per-entity hash values.

5. The method of claim 2, wherein:
each row of data corresponds to an entity and includes statistical information associated with the entity, and
the statistical information comprises at least one of impressions or conversions.

6. (canceled)

7. The method of claim 5, wherein generating the signature associated with the responsive data further comprises generating, by the one or more processors based on the entity and the statistical information associated with the entity, the signature for each row of data.

8. (canceled)

9. The method of claim 1, wherein at least one of:
the signature is generated as a function or a hash value of the responsive data, or
the signature is a representation of values of the responsive data.

10. (canceled)

11. The method of claim 9, wherein, when the signature is the representation of values:
the representation is sets of pairs, and
each pair of the sets of pairs maps a user to a corresponding value in the responsive data.

12. The method of claim 11, wherein when comparing the signature to the at least one historical query signature or the other signature, the method further comprises comparing, by the one or more processors executing an invertible bloom filter, the sets of pairs.

13. The method of claim 1, wherein:
when the query is identified as the attack, the method further comprises enabling, by the one or more processors, at least one preventative measure, and
the at least one preventative measure includes limiting query repetitions, limiting access to a dataset comprising the responsive data, inserting additional noise to the responsive data, or inserting a delay before providing the query results.

14. (canceled)

15. The method of claim 1, wherein the at least one historical query signature corresponds to a previously generated signature for data responsive to a previously received query.

16. (canceled)

17. A system, comprising:
one or more processors, the one or more processors configured to:
receive a query;
identify query results comprising data responsive to the query;
generate a signature associated with the responsive data;
compare the signature to at least one of historical query signatures or another signature associated with the responsive data; and
identify the query as an attack when the signature corresponds to at least one historical query signature or the other signature associated with the responsive data.

18. The system of claim 17, wherein the responsive data includes a plurality of rows of data such that generating the signature associated with the responsive data further comprises:
aggregating, by the one or more processors, the responsive data per row to generate an aggregated value; and
generating, by the one or more processors, the signature for each aggregated value.

19. The system of claim 18, wherein aggregating the responsive data is further aggregated per entity, and the one or more processors are further configured to:
concatenate the aggregated value with an identifier associated with the entity to generate a concatenated value; and
hash the concatenated value to generate a per-entity hash value.

20. The system of claim 19, wherein when generating the signature associated with the responsive data, the one or more processors are further configured to:
identify one or more per-entity hash values for the aggregated values; and
generate the signature associated with the responsive data by hashing the one or more per-entity hash values.

21. The system of claim 18, wherein:
each row of data corresponds to an entity and includes statistical information associated with the entity,
the statistical information comprises at least one of impressions or conversions, and
when generating the signature associated with the responsive data, the one or more processors are further configured to generate, based on the entity and the statistical information associated with the entity. the signature for each row of data.

22. (canceled)

23. (canceled)

24. (canceled)

25. The system of claim 17, wherein at least one of:
the signature is generated as a function or a hash value of the responsive data, or
the signature is a representation of values of the responsive data.

26. (canceled)

27. The system of claim 25, wherein when the signature is the representation of values:
the representation is sets of pairs,
each pair of the sets of pairs maps a user to a corresponding value in the responsive data, and
when comparing the signature to the at least one historical query signature or the other signature, the one or more processors are further configured to compare, by executing an invertible bloom filter, the sets of pairs.

28. (canceled)

29. The system of claim 17, wherein:
when the query is identified as the attack, the one or more processors are further configured to enable at least one preventative measure, and
the at least one preventative measure includes limiting query repetitions, limiting access to a dataset comprising the responsive data, inserting additional noise to the responsive data, or inserting a delay before providing the query results.

30. (canceled)

31. (canceled)

32. (canceled)

33. One or more non-transitory computer-readable storage media encoding instructions that, when executed by one or more processors, cause the one or more processors to perform operations comprising:
receiving a query;
identifying query results comprising data responsive to the query;
generating a signature associated with the responsive data;
comparing the signature to at least one of historical query signatures or another signature associated with the responsive data; and
identifying the query as an attack when the signature corresponds to at least one historical query signature or the other signature associated with the responsive data.

34-48. (canceled)
